(19) United States
(12) Patent Application Publication
(10) Pub. No.: US 2013/0268849 A1
(43) Pub. Date: Oct. 10, 2013

(54) Method and System for Multi-Party Collaborative Content Management through an Inverted Social Network

(71) Applicant: Charles Qiao Du, Singapore (SG)

(72) Inventor: Charles Qiao Du, Singapore (SG)

(21) Appl. No.: 13/442,827

(22) Filed: Apr. 9, 2012

(51) Int. Cl. G06F 17/21; G06F 15/16

(52) U.S. Cl. 715/255

(57) ABSTRACT

Method and system is disclosed which supports multi-party collaborative content creation and management using authorship controls that allow collaborators to propose in-context contributions; the author or authors to efficiently act on contributions; and multiple parties to view the latest electronic content over the Internet without installing any applications other than a web browser. The pending and historical contributions or collaborative contents may be tagged to contributor-selected sections in any current version of the document. If a pending contribution is accepted by the author, the changes proposed in the accepted contribution are merged into the document to create an updated version of the document. A reputation framework that governs how decisions on contributions impact individual reputations of contributors and authors is also disclosed. Taken together, an inverted social network is created centred around content, where users are profiled in relation to their history of content collaboration.

### BACKGROUND

1. Technical Field

Embodiments of the invention relate generally to the field of communications, and more particularly, to collaborative communication. Still more particularly, embodiments of the invention relate to a process for network collaboration through user-friendly in-context contributions, efficient decision-making, and reputation framework.

2. Description of Related Art

The ability of people to effectively and efficiently share ideas, i.e., collaborate, is at the core of team productivity. The advent of the computer and information networks facilitates collaboration over long distances and between large groups of people. Collaboration in a complex process is particularly important especially if large numbers of people are involved which potentially results in redundant, inefficient exchange of information and collective decision-making.

In order to effectively collaborate over long distances, a collaboration system must satisfy two objectives: first, a way must be found for collaborators to view the same collaborative content, regardless of their location; and second, a way must be provided to communicate opinions, changes, and illustrate points of interest in connection with the collaborative content. Ideally, this collaboration system should not require installation of custom software to accomplish these tasks because the installation of extra software introduces problems with licensing, portability, and availability to all collaborating parties.

The basic elements associated with the comment string model have remained the state-of-the-art for many years. One party creates and distributes one content element, then one or more parties add content elements in turn. More people and more posts mean ever more content, making it difficult to keep updated and creating potential for misunderstanding.

The most popular collaboration solution, i.e., electronic mail and attachments, has several disadvantages. When sending collaborative content to another collaborator, the entire history of the content generally is sent as well. The e-mail string can grow indefinitely, with multiple participants replying, forwarding, and generally adding content. E-mails could be forwarded and conversations branched with limited transparency.

The basic weblog, or blog model, improves on the email system by centralizing hosting of content and reduces the problem of branching by making the original content the dominant reference content. However the continued reliance on the comment string for feedback perpetuates the inefficient organization of additional information, opinions, and suggestions for improvements. Authors looking to collaborate must dig through tons of garbage feedback, and expend much effort to act and update the article to reflect constructive feedback. Most people, including the author, would not be able to read through an entire comment string, and most articles are sometimes never updated after the original posting, making it less than ideal for dialog and debate.

An existing competing model is the wiki framework. Editorial rights are equally granted to participants. Each participant can edit and change any number of sections of an article at the same time. Discrete elements are represented by complete versions and detailed changes are rendered only through difficult-to-read diff outputs. Anyone with rights to roll-back to a previous version would need to select which version, rather than choose which particular changes need to be reversed.

U.S. Pat. No. 7,149,776 B1 (Roy et al.) discloses a system and method for facilitating the collaborative co-browsing of a document or web page. A collaboration server retrieves content of a page on behalf of a collaboration participant or attendee. Each attendee operates or views the content with a browser that is augmented with a collaboration applet. Tags, links, script code and other references that may cause a different page to be accessed or loaded fro the current page are transformed or replaced on the server before the page is distributed to the attendees. In particular, events and redirections that may cause the attendee browser to directly navigate to another page are transformed on the server. Pre-determined rules may be applied to prevent some attendees from viewing certain content (e.g., financial or personal data). A page may be further transformed at a user browser, to redirect a hyperlink to the collaboration server or to trap some other event.

Additional information relating to collaborative systems and methods may be found in U.S. Pat. No. 7,647,373 B2 (Johnson et al.), U.S. Pat. No. 8,028,020 B2 (Huck et al.) and U.S. Pat. No. 7,305,436 B2 (Willis).

In view of the above and other problems, there is a need to improve existing collaborative systems and methods.

### BRIEF DESCRIPTION OF THE SEVERAL VIEWS OF THE DRAWING

Embodiments of the invention are disclosed hereinafter with reference to the drawings, in which:

FIG. 1 shows a conceptual block diagram of a system implementing a multi-party network collaborative content management through in-context contributions, authorship controls and reputation framework according to one embodiment of the invention;

FIG. 2 is a functional flow diagram of a computer-implemented method or sequence for multi-party collaborative content management through in-context contributions, authorship controls and reputation framework according to one embodiment of the invention;

FIG. 3A to FIG. 3G illustrate screen shots examples for the sequence of FIG. 2;

FIG. 4 illustrates a screen shot containing an Edit-type and a Challenge-type contribution.

### DETAILED DESCRIPTION OF THE INVENTION

In the following description, numerous specific details are set forth in order to provide a thorough understanding of various illustrative embodiments of the invention. It will be understood, however, to one skilled in the art, that embodiments of the invention may be practiced without some or all of these specific details. In other instances, well known process operations have not been described in detail in order not to unnecessarily obscure pertinent aspects of embodiments being described. In the drawings, like reference numerals refer to same or similar functionalities or features throughout the several views.

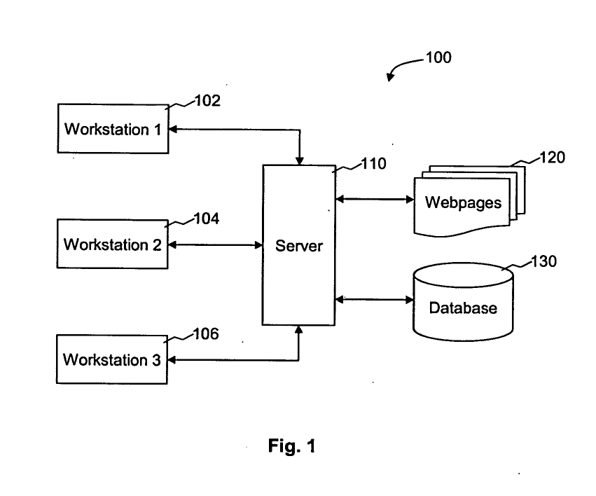

FIG. 1 shows a conceptual block diagram of a system implementing a multi-party network collaborative content management through in-context contributions, authorship controls and reputation framework according to one embodiment of the invention. The block diagram includes a plurality of user workstations 102,104,106 e.g. personal computers, portable computers, handheld devices, smart phones, etc. The user workstations 102, 104, 106 may include operating software, application programs and web browser software, e.g., Microsoft Internet Explorer or Netscape Navigator, as is known in the art. The user workstations 102, 104, 106 are connected to at least one server 110 over a computer network, e.g. Internet, Intranet. The server 110 is connected to at least one database 130 which may be used to store contents which will become apparent in the later paragraphs. The server 110 may also be connected to other servers or storage devices where webpages 120 may be stored. Hardware components and details of the above user workstations, server, databases are known in the art and may be omitted from the present disclosure for the sake of clarity.

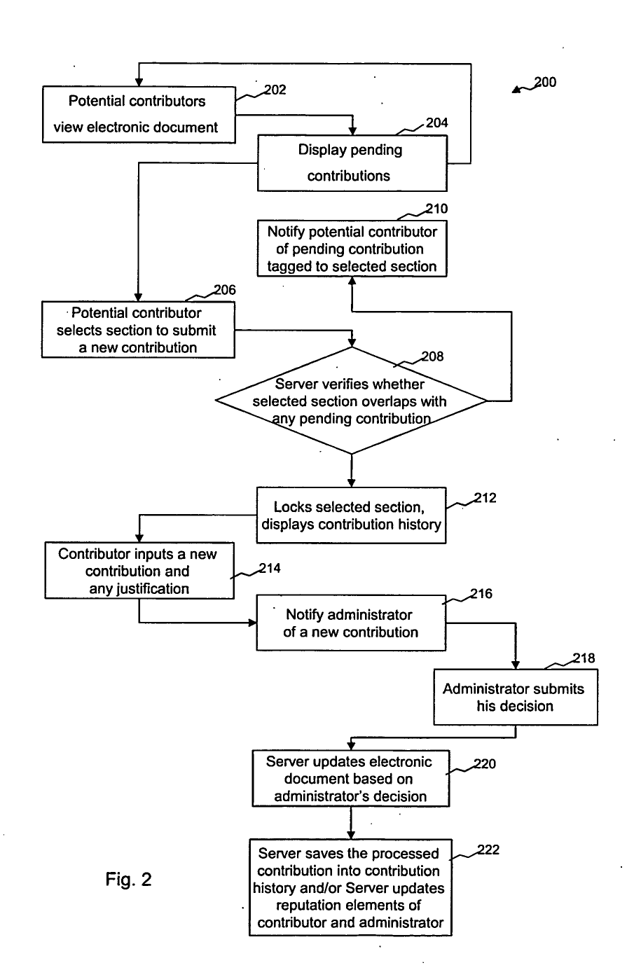

FIG. 2 is a functional flow diagram of a computer-implemented method or sequence for multi-party collaborative content management through in-context contributions, authorship controls and reputation framework according to one embodiment of the invention. The sequence of FIG. 2 may be implemented using the system represented by FIG. 1. Prior to commencing the sequence of FIG. 2, it is assumed that an author of an electronic document, e.g. article, web page, has rendered the electronic document over a computer network e.g. Internet, and made the document available for viewing by potential contributors over their user workstations. The potential contributors may include the general public users or a closed group of users. The author may be the original author of the document or any person authorized with editorial control over the electronic document.

The sequence 200 may begin with one or more potential contributors viewing the electronic document (step 202). The document may be viewed over the Internet without installing dedicated application programs other than a web browser. The document may contain one or more pending in-context contributions which have not been decided upon by the author of the document. The pending contributions may relate to one or more different sections of the document, and may be submitted by one or more contributors. The server renders the pending contributions together with the electronic document over the network. The pending contributions may be displayed on user workstations in association with their respective content sections in question (step 204).

If a potential contributor decides to create a new contribution or collaborative content, he selects a certain desired section of the electronic document, e.g. a contiguous section of paragraph(s), sentence(s), or word(s), for which the new contribution will be tagged to or associated with (step 206). Selecting a section of the document may be performed using known methods, e.g. using a mouse or a finger on a touch-sensitive screen. After the potential contributor selects the desired document section, the server determines whether the selected document section is currently tagged or associated with any other pending in-context contribution (step 208).

If the server determines that the selected document section is currently tagged or associated with a pending contribution, or overlaps with another document section which is currently tagged or associated with a pending contribution, the server will notify the potential contributor appropriately (step 210). Particularly, the server will notify the potential contributor that the document section which he has selected has a pending contribution and that the potential contributor is therefore disallowed from creating a new contribution for that selected document section. (Only one pending contribution is allowed for each selected document section. Allowing more than one pending contribution for a selected section may potentially result in a latter contribution rendered meaningless if an earlier contribution is accepted by the author.) The server then disregards the selected document section and waits for the potential contributor to select another document section (step 202). After the potential contributor subsequently selects another document section, the server repeats the verification step of 210 on the newly-selected document section.

If the server determines that the selected document section does not contain any pending contribution or parts thereof, the server locks the selected document section and awaits submission of a new contribution from the potential contributor who selected this particular document section. This way, other potential contributors who are viewing the document at the same time are prevented from selecting the same document section for creating a new contribution. Further, the contribution history associated with the selected document section may be displayed for the contributor's reference (step 212). Particularly, the server may retrieve from an appropriate database and display past contributions associated with the selected document section. The contribution history being displayed may include past contributions which have been accepted and/or rejected. An indication of the status (e.g. accepted, rejected) may be displayed. An appropriate user interface may be used to display the contribution history.

The contributor may proceed to input his new contribution in relation to the selected document section (step 214). The new contribution may take one of various types including, but not limited to, an Edit (which involves amending or deleting the contents, e.g. text element, in the selected document section), or a Challenge (which involves submitting a piece of contrary evidence or argument). Optionally, the contributor may also input explanations or supporting materials justifying the new contribution, e.g. attach files and/or links, or input general feedback about the selected document section. Appropriate user interface and mechanism are provided to allow the contributor submit and transmit his new contribution over the network to the server.

After the new contribution is submitted and received at the server, the server notifies the author of the new pending contribution and requests the author to act on the pending contribution (step 216). At a convenient time, the author reviews the pending contribution and takes a decision on the pending contribution (step 218). Particularly, the author's decision may take one of various types including, but not limited to, Accepting or Rejecting the contribution. An appropriate user interface may be provided to present various options to the author and to receive the author's decision.

After the author's decision on a pending contribution is submitted and received at the server, the document is updated appropriately depending on the contribution type (step 220). For example, if a contribution relates to an Edit, an acceptance of the Edit-type contribution incorporates the proposed edits into the document, while a rejection of the Edit-type contribution will result in the document remain unchanged. If the contribution relates to a Challenge, no decision on the Challenge-type contribution will result in the document being changed, but would show up in history reflecting the decision made. Optionally, the author may also input his explanation for the decision. The author's explanation may be viewed by the relevant contributor and/or all viewers.

Further, the server unlocks the document section affected by the processed contribution to allow other potential contributors to select the same document section for submitting new contributions. Optionally, the server may store or record the processed contribution (which has been accepted or rejected) in the contribution history such as by storing the processed contribution in an appropriate database (step 222). The contributory history may be retrieved as and when required.

Further, the reputation elements of the contributor, the author and, potentially, the contributor's sponsor may be appropriately updated depending on the decision taken for the processed contribution (step 222). For example, the reputation of the author improves if the author has accepted a contribution; the reputation of a contributor improves if his contribution has been accepted. Presentation of the reputation framework may be implemented using known models. Further, the reputation framework may allow an author to label a contributor as a Troll which will damage the reputation of the contributor and his sponsor (who has invited or introduced the contributor). Optionally, contributors labelled as Trolls may be disallowed from submitting future contributions to the author.

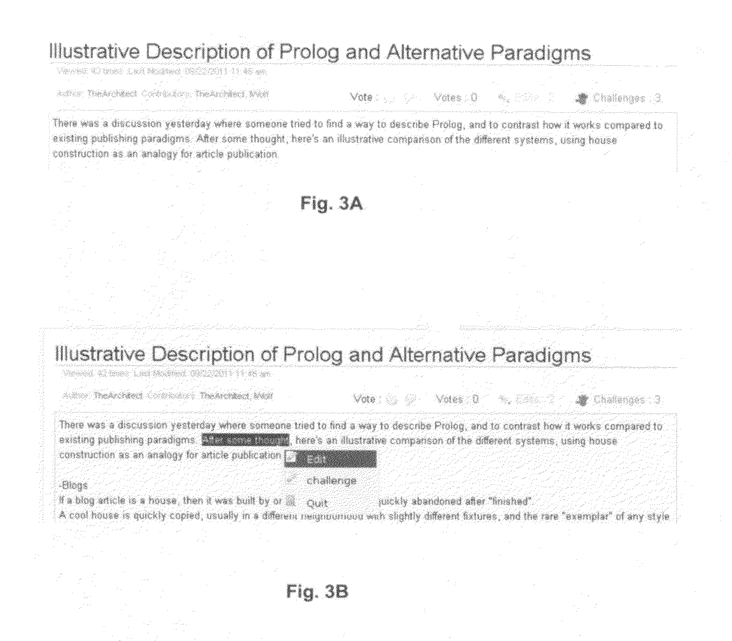

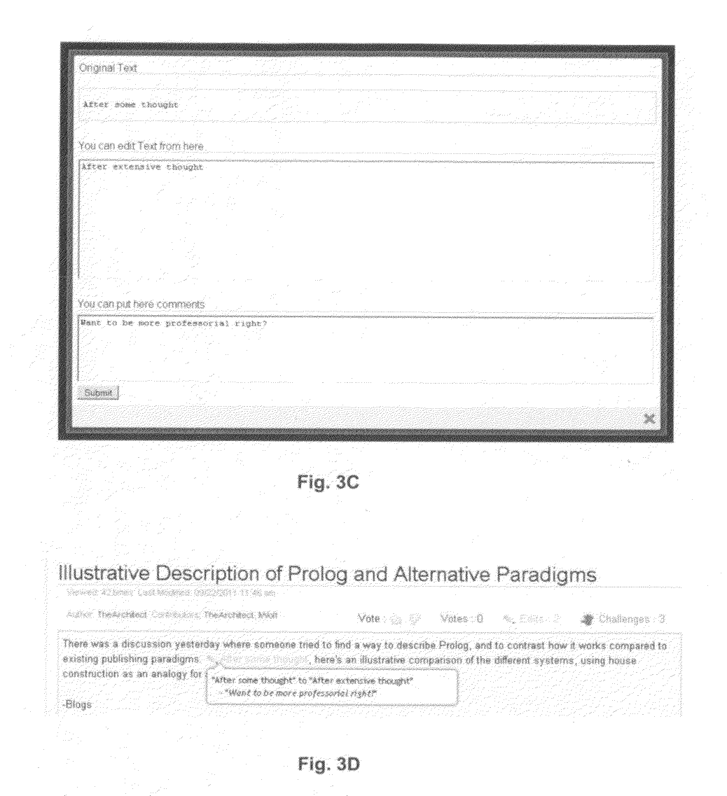

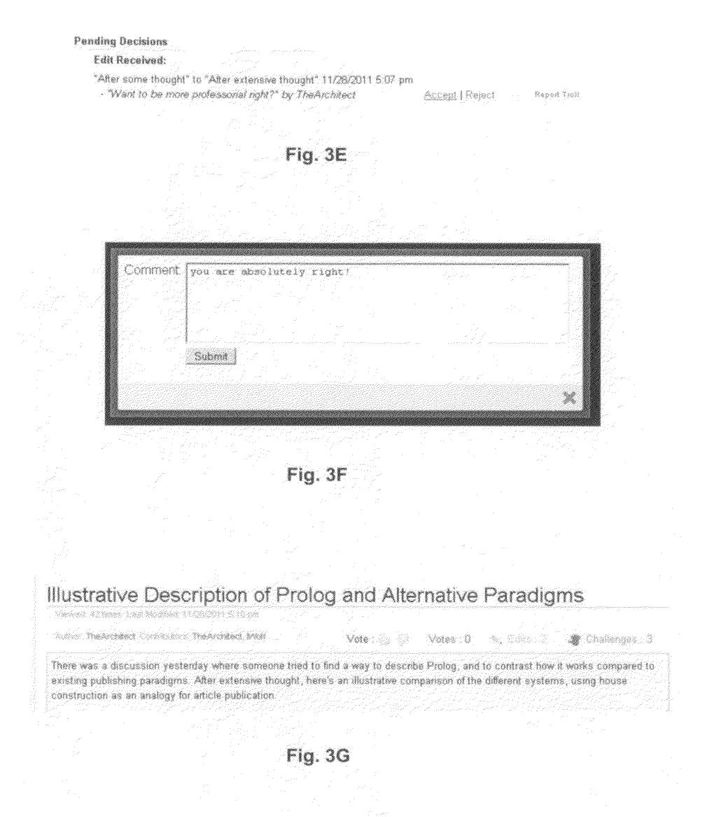

FIG. 3A to FIG. 3G illustrate some screen shot examples for the sequence of FIG. 2. FIG. 3A shows an electronic document, e.g. webpage, that does not contain pending contributions and is available to receive new contributions. FIG. 3B shows the web page of FIG. 3A in which a potential contributor has selected a section for submitting a contribution and is selecting the contribution type. FIG. 3C shows a user interface where the contributor inputs an Edit-type contribution. The user interface of FIG. 3C includes displaying the original text, appropriate input fields for receiving a new contribution e.g. proposed text edits, and the contributor's justification for the new contribution. FIG. 3D illustrates a pending contribution which is displayed in association with the selected document section for viewing by potential contributors. A visual cue, which may be a marker, a cursor, an icon; a marquee box, or a similarly distinctive interface item, may be displayed to indicate the status of the contribution. FIG. 3E illustrates a notification to the author of the pending contribution. The notification may include the proposed text edits, justification, identity of the contributor and time stamp, and also allow the author to submit his decision, e.g. Accept and Reject. The user interface of FIG. 3E may also allow the author to report a contributor as a Troll where appropriate. FIG. 3F illustrates a user interface that allows the author to submit any explanation or feedback to the contributor after submitting his decision on the contribution. FIG. 3G illustrates the web page after the author's decision is submitted. In this example, the author had accepted the contribution, and, accordingly, the web page has been updated to incorporate the proposed text of the contribution and the number of Edits has been updated accordingly.

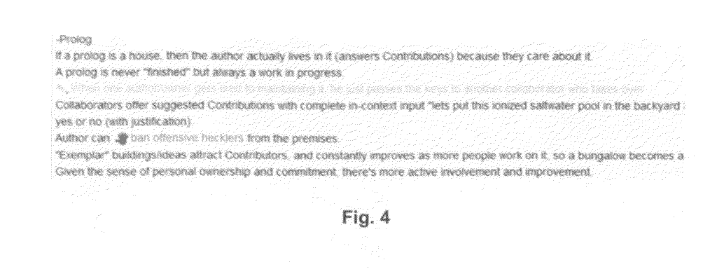

Separately, FIG. 4 illustrates an electronic document containing an Edit-type pending contribution and a Challenge-type pending contribution. Each pending contribution may be highlighted and/or preceded by a distinctive symbol acting as a visual cue.

Embodiments of the invention allow multiple parties to collaboratively create and manage an electronic document over a computing network without having to install dedicated applications other than a web browser. The collaboration system allows multiple parties to propose contributions or collaborative content in respect of the selected document sections and view pending contributions tagged to the respective selected document sections. The collaboration system also provides a notification system for notifying the authors to evaluate and act on the pending contributions. The collaboration system further receives decisions submitted by the authors and updates the document based on the decision received. The collaboration provides a reputation framework which governs the individual reputations of authors and contributors based on their contributions and decisions. This way, a more streamlined, constructive and civil system and method of collaborative content creation of content is achieved.

Other embodiments will be apparent to those skilled in the art from consideration of the specification and practice of the invention. Furthermore, certain terminology has been used for the purposes of descriptive clarity, and not to limit the disclosed embodiments of the invention. The embodiments and features described above should be considered exemplary, with the invention being defined by the appended claims.

What is claimed is:

1. A computer-implemented method for multi-party collaborative content management, the method comprising the steps of:
receiving a selected document section of an electronic document from a contributor;
receiving an item of collaborative content from the contributor, wherein the collaborative content is either categorized as a proposed edit or a proposed challenge to the selected document section;
providing the collaborative content to an author of the overall article for deciding between an acceptance and a rejection decision;
updating the electronic document based on a decision of the author; and
updating a reputation element of the contributor and the author based on the decision of the author.

2. A method as recited in claim 1, further comprising:
receiving from the contributor a justification associated with the collaborative content.

3. A method as recited in claim 1, wherein the justification includes at least one of a file attachment and a website link.

4. A method as recited in claim 1, wherein the collaborative content includes a text element.

5. A method as recited in claim 1, further comprising the provision of a visual cue to indicate the status of the collaborative content.

6. A method as recited in claim 2, further comprising:
before receiving a collaborative content from the contributor, verifying whether the selected document section is currently associated with a pending collaborative content item.

7. A method as recited in claim 6, further comprising:
disallowing the receiving of a newly proposed collaborative content item from the contributor if the selected document section is currently associated with a pending collaborative content item.

8. A method as recited in claim 6, further comprising:
after verifying whether the selected document section is currently associated with a pending collaborative content item, locking the selected document section for receiving the collaborative content from the contributor.

9. A method as recited in claim 8, further comprising:
receiving from the author an explanation for the decision.

10. A method as recited in claim 8, further comprising:
after updating the electronic document based on a decision of the author, storing the collaborative content in a database.

11. A method as recited in claim 8, further comprising:
after updating the electronic document based on a decision of the author, unlocking the selected document section to allow another contributor to submit a new collaborative content item.

12. A system for facilitating multi-party collaborative content management, comprising:
a number of servers coupled over a network to a plurality of workstations of at least a contributor and an administrator;
a number of databases coupled to the servers,
wherein a server receives a collaborative content item from the contributor, which is categorized as either a proposed edit or a proposed challenge to a selected section of an electronic document, the server further provides the collaborative content to the author for deciding between an acceptance and a rejection decision and updates the electronic document based on that decision by the author, and the server further updates a reputation element of the contributor and the author based on the decision of the author.

13. A system as recited in claim 12, wherein the server receives a justification from the contributor in relation to the collaborative content.

14. A system as recited in claim 13, wherein the server verifies whether the selected document section is currently associated with a pending collaborative content item before allowing a new item of proposed collaborative content from the contributor.

15. A system as recited in claim 14, wherein the server disallows receipt of a collaborative content item from the contributor if the selected document section is currently associated with a pending collaborative content item.

16. A system as recited in claim 14, wherein the server locks the selected document section for receiving the collaborative content from the contributor after verifying whether the selected document section is currently associated with a pending collaborative content item.

17. A system as recited in claim 14, wherein the server stores the collaborative content in a database or other persistent storage after updating the electronic document based on the decision of the author.

18. A system as recited in claim 14, wherein after the server updates the electronic document based on the decision of the author, the server unlocks the selected document section for allowing another contributor to submit a new collaborative content.
